(19) United States
(12) Patent Application Publication
(10) Pub. No.: US 2026/0304068 A1
(43) Pub. Date: Oct. 1, 2026

(54) Enhanced Geolocation Cache Service

(71) Applicant: Zscaler, Inc., San Jose, CA (US)

(72) Inventors: Gopi Selvarajan, San Jose, CA (US); Pankaj Chhabra, Burnaby (CA); Sreeni Tellakula, San Jose, CA (US)

(73) Assignee: Zscaler, Inc., San Jose, CA (US)

(21) Appl. No.: 19/092,147

(22) Filed: Mar. 27, 2025

(51) Int. Cl. H04W 4/02; H04W 4/029; H04W 8/26

(52) U.S. Cl. CPC H04W 4/023; H04W 4/029; H04W 8/26

(57) ABSTRACT

Systems and methods for geolocating an Access Point (AP) based on network identifiers and external data sources includes caching the AP's location by associating it with one or more network identifiers, deriving an egress IP address of the AP from an external tool or service, and generating a unique key based on the egress IP address. The unique key can be used to geolocate the AP. Such systems and methods can be incorporated with location based services.

### FIELD OF THE DISCLOSURE

The present disclosure generally relates to network and cloud security. More particularly, the present disclosure relates to systems and methods for enhancing the accuracy of geolocation services.

### BACKGROUND OF THE DISCLOSURE

For a nomadic subscriber who moves along with the Access Point (AP) to a different location, relying solely on caching based on the AP MAC addresses fails to produce an accurate geolocation result. This is because the BSSID-to-geolocation cache relies on a key that does not incorporate dynamic components such as longitude and latitude, leading to incorrect location mappings. Incorporating longitude and latitude into the caching key poses significant challenges, as doing so would exponentially increase the size of the database. For instance, to accurately account for even slight variations in geographic coordinates, the system would need to store an overwhelming amount of data for each degree of variation in both longitude and latitude, resulting in an impractical and inefficient caching solution. This fundamental inefficiency highlights the shortcomings of using simplistic MAC-based or coordinate-dense caching mechanisms for geolocation accuracy in mobile or nomadic environments.

Furthermore, the absence of an effective caching mechanism creates additional problems, including increased reliance on external geolocation services. This reliance introduces latency, escalates operational costs, and diminishes overall customer satisfaction due to longer response times. Additionally, in scenarios where the network experiences failures in northbound communication, such as disruptions in API calls to third-party geolocation services, subscribers may encounter outages or severely degraded experiences. For nomadic subscribers, this problem is exacerbated because geolocation queries are often performed at times when the AP has moved to a new location, and without other active APs in proximity to verify location, the third-party service may return inaccurate or null information. This limitation underscores the need for innovative approaches that strike a balance between database manageability, real-time accuracy, and resilience against network or service failures.

### BRIEF SUMMARY OF THE DISCLOSURE

The present disclosure relates to systems and methods for enhanced geolocation cache services. In various embodiments, the present disclosure includes a method having steps, a processing device configured to implement the steps, a cloud-based system configured to implement the steps, and as a non-transitory computer-readable medium storing instructions for programming one or more processors to execute the steps. The method of the present disclosure can determine or update the geolocation of an Access Point (AP). In example, the method can utilize network identifiers like the Basic Service Set Identifier (BSSID) or egress IP address. The process can include caching the AP's location, deriving its egress IP address using external tools or services, and using the IP address to create a unique key for geolocation determination. The geolocation, which can be defined by longitude and latitude, can be dynamically updated based on the movement of the AP. The movement of the AP can be determined based on a change in egress IP address. The method also includes supporting geolocation updates based on proximity to another AP triangulation using egress IP and can be utilized with both fixed and mobile AP while allowing caching and monitoring to enhance efficiency.

In one aspect, disclosed is a method including steps of caching a location of an Access Point (AP) based on one or more network identifiers of the AP, deriving an egress IP address of the AP from one of an external tool or service, determining a unique key based on the egress IP address, and identifying a geolocation of the AP based on the unique key.

In another aspect, disclosed is A non-transitory computer-readable medium including instructions that, when executed, cause one or more processors to perform steps of caching a location of an Access Point (AP) based on one or more network identifiers of the AP, deriving, at an instant, an egress IP address of the AP from one of an external tool or service, determining a unique key based on the egress IP address, and identifying a geolocation of the AP based on the unique key.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1A is a network diagram of three example network configurations of cybersecurity monitoring and protection of a user.

FIG. 1B is a logical diagram of the cloud operating as a zero-trust platform.

FIG. 2 is a block diagram of a server.

FIG. 3 is a block diagram of a computing device.

FIG. 4 is a diagram of an exemplary network configuration illustrating an application on computing devices configured to operate through the cloud.

FIG. 5 is diagram depicting an exemplary aspect of conventional geolocation architecture.

FIG. 6 is a diagram depicting an exemplary aspect of a geolocation architecture in accordance with one aspect of the present disclosure.

FIG. 7 is a flowchart depicting a method for geolocation in accordance with another aspect of the present disclosure.

### DETAILED DESCRIPTION OF THE DISCLOSURE

Again, the present disclosure relates to systems and methods for enhanced geolocation cache services. More specifically, the instant disclosure provides systems and methods for determining and tracking the geolocation of an Access Point (AP). The tracking can be accomplished using network and IP-related information. The method can include leveraging one or more identifiers of the AP, such as Basic Service Set Identifiers (BSSID) or egress IP addresses, to cache and associate the AP's geolocation, which can be updated as needed. One outcome of the present method includes providing a reliable way to locate and monitor the movement of an AP.

The system and methods of the present disclosure include caching the location of an AP based on its network identifiers and deriving its egress IP address using external tools or services. A unique key can be generated from the egress IP address, which can be then used to identify the geolocation of the AP. Several types of network identifiers are contemplated for use (e.g., BSSID, IPv4, IPv6, etc.) which can clarify the geolocation in terms of longitude and latitude. The method can include monitoring the movement of an AP by detecting changes in its egress IP address and updating the cached geolocation accordingly. It is envisioned that the method can be applied to geolocate mobile APs as well.

More generally, the present disclosure includes a system for geolocation and tracking of APs. In example only, the method includes utilizing a combination of network identifiers, IP-based information, caching mechanisms, and optionally triangulation. The method can be configured to accommodate both fixed and mobile APs, provides tools for tracking changes over time, and can allow geolocation to be determined with increased precision.

### § 1.0 Cybersecurity Monitoring and Protection Examples

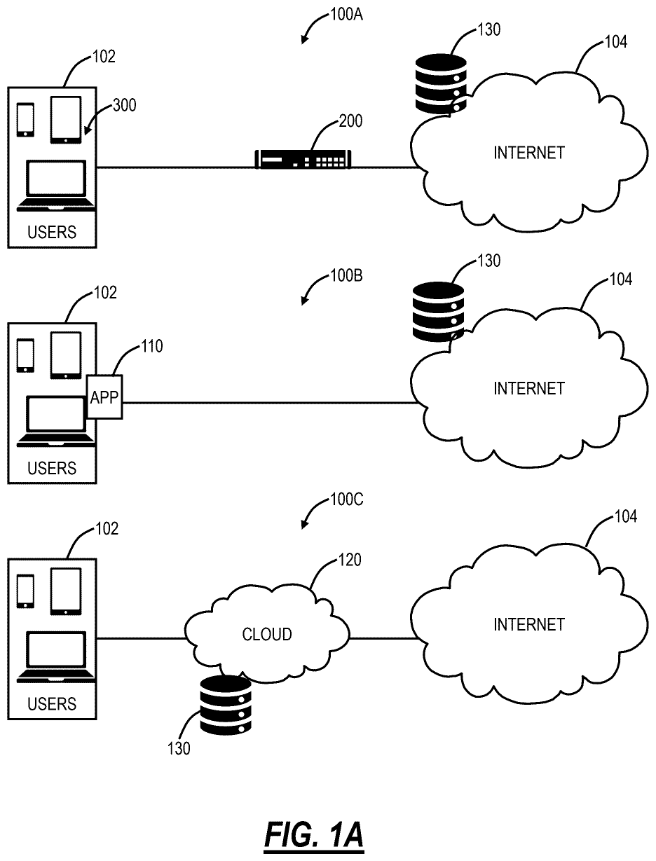

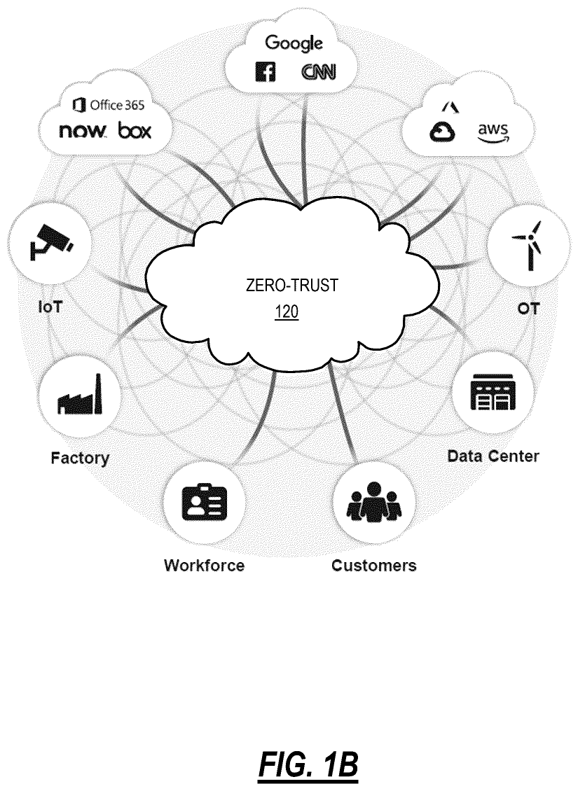

FIG. 1A is a network diagram of three example network configurations 100A, 100B, 100C of cybersecurity monitoring and protection of an endpoint 102. Those skilled in the art will recognize these are some examples for illustration purposes, there may be other approaches to cybersecurity monitoring (as well as providing generalized services), and these various approaches can be used in combination with one another as well as individually. Also, while shown for a single endpoint 102, practical embodiments will handle a large volume of endpoints 102, including multi-tenancy. In this example, the endpoint 102 communicates on the Internet 104, including accessing cloud services, Software-as-a-Service, etc. (each may be offered via computing resources, such as, e.g., using one or more servers 200 as illustrated in FIG. 2).

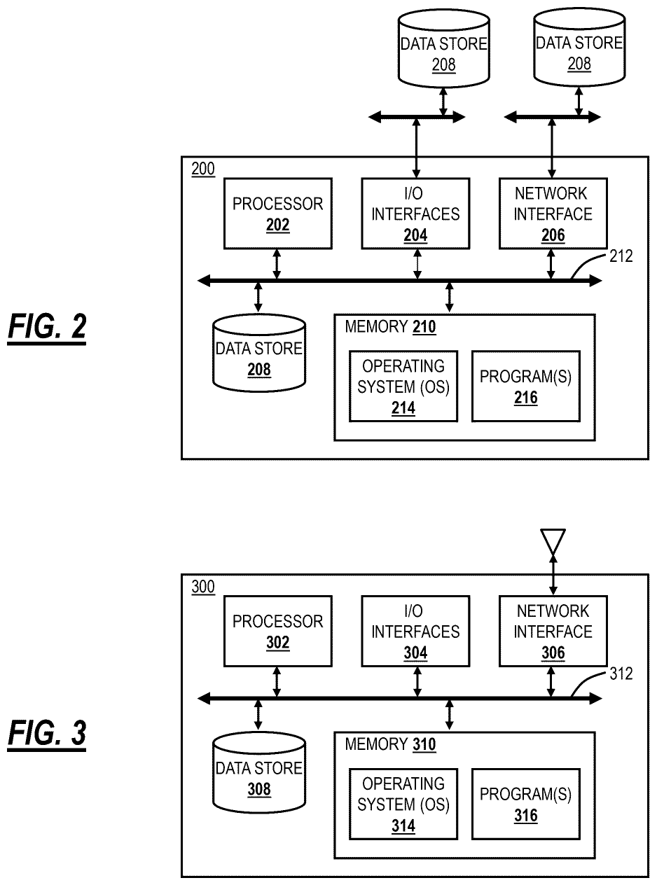

Note, the term endpoint 102 is used herein to refer to any computing device (see FIG. 3 for an example computing device 300) which can communicate on a network. The endpoint 102 can be associated with a user and include laptops, tablets, mobile phones, desktops, etc. Further, the endpoint can also mean machines, workloads, IoT devices, or simply anything associated with the company that connects to the Internet, a Local Area Network (LAN), etc.

As part of offering cybersecurity through these example network configurations 100A, 100B, 100C, there is a large amount of cybersecurity data obtained. Various embodiments of the present disclosure focus on using this cybersecurity data along with a customer's data to perform various security tasks including developing customer machine learning models and other security platforms of the like.

The network configuration 100A includes a server 200 located between the endpoint 102 and the Internet 104. For example, the server 200 can be a proxy, a gateway, a Secure Web Gateway (SWG), Secure Internet and Web Gateway, Secure Access Service Edge (SASE), Secure Service Edge (SSE), Cloud Application Security Broker (CASB), etc. The server 200 is illustrated located in line with the endpoint 102 and configured to monitor the endpoint 102. In other embodiments, the server 200 does not have to be inline. For example, the server 200 can monitor requests from the endpoint 102 and responses to the endpoint 102 for one or more security purposes, as well as allow, block, warn, and log such requests and responses. The server 200 can be on a local network associated with the endpoint 102 as well as external, such as on the Internet 104. Also, while described as a server 200, this can also be a router, switch, appliance, virtual machine, etc. The network configuration 100B includes an application 110 that is executed on the computing device 300. The application 110 can perform similar functionality as the server 200, as well as coordinated functionality with the server 200 (a combination of the network configurations 100A, 100B). Finally, the network configuration 100C includes a cloud service 120 configured to monitor the endpoint 102 and perform security-as-a-service. Of course, various embodiments are contemplated herein, including combinations of the network configurations 100A, 100B, 100C together.

The cybersecurity monitoring and protection can include firewall, intrusion detection and prevention, Uniform Resource Locator (URL) filtering, content filtering, bandwidth control, Domain Name System (DNS) filtering, protection against advanced threat (malware, spam, Cross-Site Scripting (XSS), phishing, etc.), data protection, sandboxing, antivirus, and any other security technique. Any of these functionalities can be implemented through any of the network configurations 100A, 100B, 100C. A firewall can provide Deep Packet Inspection (DPI) and access controls across various ports and protocols as well as being application and user aware. The URL filtering can block, allow, or limit website access based on policy for a user, group of users, or entire organization, including specific destinations or categories of URLs (e.g., gambling, social media, etc.). The bandwidth control can enforce bandwidth policies and prioritize critical applications such as relative to recreational traffic. DNS filtering can control and block DNS requests against known and malicious destinations.

The intrusion prevention and advanced threat protection can deliver full threat protection against malicious content such as browser exploits, scripts, identified botnets and malware callbacks, etc. The sandbox can block zero-day exploits (just identified) by analyzing unknown files for malicious behavior. The antivirus protection can include antivirus, antispyware, antimalware, etc. protection for the endpoints 102, using signatures sourced and constantly updated. The DNS security can identify and route command-and-control connections to threat detection engines for full content inspection. The DLP can use standard and/or custom dictionaries to continuously monitor the endpoints 102, including compressed and/or Transport Layer Security (TLS) or Secure Sockets Layer (SSL)-encrypted traffic.

In typical embodiments, the network configurations 100A, 100B, 100C can be multi-tenant and can service a large volume of the endpoints 102. Newly discovered threats can be promulgated for all tenants practically instantaneously. The endpoints 102 can be associated with a tenant, which may include an enterprise, a corporation, an organization, etc. That is, a tenant is a group of users who share a common grouping with specific privileges, i.e., a unified group under some IT management. The present disclosure can use the terms tenant, enterprise, organization, enterprise, corporation, company, etc. interchangeably and refer to some group of endpoints 102 under management by an IT group, department, administrator, etc., i.e., some group of endpoints 102 that are managed together. One advantage of multi-tenancy is the visibility of cybersecurity threats across a large number of endpoints 102, across many different organizations, across the globe, etc. This provides a large volume of data to analyze, use machine learning techniques on, develop comparisons, etc. The present disclosure can use the term “service provider” to denote an entity providing the cybersecurity monitoring and a “customer” as a company (or any other grouping of endpoints 102).

Of course, the cybersecurity techniques above are presented as examples. Those skilled in the art will recognize other techniques are also contemplated herewith. That is, any approach to cybersecurity that can be implemented via any of the network configurations 100A, 100B, 100C. Also, any of the network configurations 100A, 100B, 100C can be multi-tenant with each tenant having its own endpoints 102 and configuration, policy, rules, etc.

### § 1.1 Cloud Monitoring

The cloud 120 can scale cybersecurity monitoring and protection with near-zero latency on the endpoints 102. Also, the cloud 120 in the network configuration 100C can be used with or without the application 110 in the network configuration 100B and the server 200 in the network configuration 100A. Logically, the cloud 120 can be viewed as an overlay network between endpoints 102 and the Internet 104 (and cloud services, SaaS, etc.). Previously, the IT deployment model included enterprise resources and applications stored within a data center (i.e., physical devices) behind a firewall (perimeter), accessible by employees, partners, contractors, etc. on-site or remote via Virtual Private Networks (VPNs), etc. The cloud 120 replaces the conventional deployment model. The cloud 120 can be used to implement these services in the cloud without requiring the physical appliances and management thereof by enterprise IT administrators. As an ever-present overlay network, the cloud 120 can provide the same functions as the physical devices and/or appliances regardless of geography or location of the endpoints 102, as well as independent of platform, operating system, network access technique, network access provider, etc.

There are various techniques to forward traffic between the endpoints 102 and the cloud 120. A key aspect of the cloud 120 (as well as the other network configurations 100A, 100B) is that all traffic between the endpoints 102 and the Internet 104 is monitored. All of the various monitoring approaches can include log data 130 accessible by a management system, management service, analytics platform, and the like. For illustration purposes, the log data 130 is shown as a data storage element and those skilled in the art will recognize the various compute platforms described herein can have access to the log data 130 for implementing any of the techniques described herein for risk quantification. In an embodiment, the cloud 120 can be used with the log data 130 from any of the network configurations 100A, 100B, 100C, as well as other data from external sources.

The cloud 120 can be a private cloud, a public cloud, a combination of a private cloud and a public cloud (hybrid cloud), or the like. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “Software-as-a-Service” (SaaS) is sometimes used to describe application programs offered through cloud computing. A common shorthand for a provided cloud computing service (or even an aggregation of all existing cloud services) is “the cloud.” The cloud 120 contemplates implementation via any approach known in the art.

The cloud 120 can be utilized to provide example cloud services, including Zscaler Internet Access (ZIA), Zscaler Private Access (ZPA), Zscaler Workload Segmentation (ZWS), and/or Zscaler Digital Experience (ZDX), all from Zscaler, Inc. (the assignee and applicant of the present application). Also, there can be multiple different clouds 120, including ones with different architectures and multiple cloud services. The ZIA service can provide the access control, threat prevention, and data protection. ZPA can include access control, microservice segmentation, etc. The ZDX service can provide monitoring of user experience, e.g., Quality of Experience (QoE), Quality of Service (QoS), etc., in a manner that can gain insights based on continuous, inline monitoring. For example, the ZIA service can provide a user with Internet Access, and the ZPA service can provide a user with access to enterprise resources instead of traditional Virtual Private Networks (VPNs), namely ZPA provides Zero Trust Network Access (ZTNA). Those of ordinary skill in the art will recognize various other types of cloud services are also contemplated.

### § 1.2 Zero Trust

FIG. 1B is a logical diagram of the cloud 120 operating as a zero-trust platform. Zero trust is a framework for securing organizations in the cloud and mobile world that asserts that no user or application should be trusted by default. Following a key zero trust principle, least-privileged access, trust is established based on context (e.g., user identity and location, the security posture of the endpoint, the app or service being requested) with policy checks at each step, via the cloud 120. Zero trust is a cybersecurity strategy where security policy is applied based on context established through least-privileged access controls and strict user authentication—not assumed trust. A well-tuned zero trust architecture leads to simpler network infrastructure, a better user experience, and improved cyberthreat defense.

Establishing a zero-trust architecture requires visibility and control over the environment's users and traffic, including that which is encrypted; monitoring and verification of traffic between parts of the environment; and strong multi-factor authentication (MFA) approaches beyond passwords, such as biometrics or one-time codes. This is performed via the cloud 120. Critically, in a zero-trust architecture, a resource's network location is not the biggest factor in its security posture anymore. Instead of rigid network segmentation, your data, workflows, services, and such are protected by software-defined micro segmentation, enabling you to keep them secure anywhere, whether in your data center or in distributed hybrid and multi-cloud environments.

The core concept of zero trust is simple: assume everything is hostile by default. It is a major departure from the network security model built on the centralized data center and secure network perimeter. These network architectures rely on approved IP addresses, ports, and protocols to establish access controls and validate what's trusted inside the network, generally including anybody connecting via remote access VPN. In contrast, a zero-trust approach treats all traffic, even if it is already inside the perimeter, as hostile. For example, workloads are blocked from communicating until they are validated by a set of attributes, such as a fingerprint or identity. Identity-based validation policies result in stronger security that travels with the workload wherever it communicates—in a public cloud, a hybrid environment, a container, or an on-premises network architecture.

Because protection is environment-agnostic, zero trust secures applications and services even if they communicate across network environments, requiring no architectural changes or policy updates. Zero trust securely connects users, devices, and applications using business policies over any network, enabling safe digital transformation. Zero trust is about more than user identity, segmentation, and secure access. It is a strategy upon which to build a cybersecurity ecosystem.

At its core are three tenets:
Terminate every connection: Technologies like firewalls use a “passthrough” approach, inspecting files as they are delivered. If a malicious file is detected, alerts are often too late. An effective zero trust solution terminates every connection to allow an inline proxy architecture to inspect all traffic, including encrypted traffic, in real time—before it reaches its destination—to prevent ransomware, malware, and more.
Protect data using granular context-based policies: Zero trust policies verify access requests and rights based on context, including user identity, device, location, type of content, and the application being requested. Policies are adaptive, so user access privileges are continually reassessed as context changes.
Reduce risk by eliminating the attack surface: With a zero-trust approach, users connect directly to the apps and resources they need, never to networks (see ZTNA). Direct user-to-app and app-to-app connections eliminate the risk of lateral movement and prevent compromised devices from infecting other resources. Plus, users and apps are invisible to the internet, so they cannot be discovered or attacked.

### § 1.3 Log Data

With the cloud 120 as well as any of the network configurations 100A, 100B, 100C, the log data 130 can include a rich set of statistics, logs, history, audit trails, and the like related to various endpoint 102 transactions. Generally, this rich set of data can represent activity by an endpoint 102. This information can be for multiple endpoints 102 of a company, organization, etc., and analyzing this data can provide a wealth of information as well as training data for machine learning models.

The log data 130 can include a large quantity of records used in a backend data store for queries. A record can be a collection of tens of thousands of counters. A counter can be a tuple of an identifier (ID) and value. As described herein, a counter represents some monitored data associated with cybersecurity monitoring. Of note, the log data can be referred to as sparsely populated, namely a large number of counters that are sparsely populated (e.g., tens of thousands of counters or more, and possible orders of magnitude or more of which are empty). For example, a record can be stored every time period (e.g., an hour or any other time interval). There can be millions of active endpoints 102 or more. Examples of the sparsely populated log data can be the Nanolog system from Zscaler, Inc., the applicant.

Also, such data is described in the following:

Commonly-assigned U.S. Pat. No. 8,429,111, issued Apr. 23, 2013, and entitled “Encoding and compression of statistical data,” the contents of which are incorporated herein by reference, describes compression techniques for storing such logs,

Commonly-assigned U.S. Pat. No. 9,760,283, issued Sep. 12, 2017, and entitled “Systems and methods for a memory model for sparsely updated statistics,” the contents of which are incorporated herein by reference, describes techniques to manage sparsely updated statistics utilizing different sets of memory, hashing, memory buckets, and incremental storage, and

Commonly-assigned U.S. patent application Ser. No. 16/851,161, filed Apr. 17, 2020, and entitled “Systems and methods for efficiently maintaining records in a cloud-based system,” the contents of which are incorporated herein by reference, describes compression of sparsely populated log data.

A key aspect here is that the cybersecurity monitoring is rich and provides a wealth of information to determine various assessments of cybersecurity. In some embodiments, the log data 130 can be referred to as weblogs or the like. Of note, with various cybersecurity monitoring techniques via the network configurations 100A, 100B, 100C, as well as with other network configurations, the log data 130 is a rich repository of endpoint 102 activity. Unlike websites, specific cloud services, application providers, etc., cybersecurity monitoring can log almost all of a user's 102 activity. That is, the log data 130 is not merely confined to specific activity (e.g., a user's 102 social networking activity on a specific site, a user's 102 search requests on a specific search engine, etc.).

### § 2.0 Example Server Architecture

FIG. 2 is a block diagram of a server 200, which may be used as a destination on the Internet, for the network configuration 100A, etc. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 2 depicts the server 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a Central Processing Unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components.

The network interface 206 may be used to enable the server 200 to communicate on a network, such as the Internet 104. The network interface 206 may include, for example, an Ethernet card or adapter or a Wireless Local Area Network (WLAN) card or adapter. The network interface 206 may include address, control, and/or data connections to enable appropriate communications on the network. A data store 208 may be used to store data. The data store 208 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., SCSI or USB connection). In a further embodiment, the data store 208 may be connected to the server 200 through a network, such as, for example, a network-attached file server.

The memory 210 may include any volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable Operating System (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein. Those skilled in the art will recognize the cloud 120 ultimately runs on one or more physical servers 200, virtual machines, etc..

### § 3.0 Example Computing Device Architecture

FIG. 3 is a block diagram of a computing device 300, which may be realize an endpoint 102. Specifically, the computing device 300 can form a device used by one of the endpoints 102, and this may include common devices such as laptops, smartphones, tablets, netbooks, personal digital assistants, cell phones, e-book readers, Internet-of-Things (IoT) devices, servers, desktops, printers, televisions, streaming media devices, storage devices, and the like, i.e., anything that can communicate on a network. The computing device 300 can be a digital device that, in terms of hardware architecture, generally includes a processor 302, I/O interfaces 304, a network interface 306, a data store 308, and memory 310. It should be appreciated by those of ordinary skill in the art that FIG. 3 depicts the computing device 300 in an oversimplified manner, and a practical embodiment may include additional components and suitably configured processing logic to support known or conventional operating features that are not described in detail herein. The components (302, 304, 306, 308, and 302) are communicatively coupled via a local interface 312. The local interface 312 can be, for example, but not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a CPU, an auxiliary processor among several processors associated with the computing device 300, a semiconductor-based microprocessor (in the form of a microchip or chipset), or generally any device for executing software instructions. When the computing device 300 is in operation, the processor 302 is configured to execute software stored within the memory 310, to communicate data to and from the memory 310, and to generally control operations of the computing device 300 pursuant to the software instructions. In an embodiment, the processor 302 may include a mobile-optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, a barcode scanner, and the like. System output can be provided via a display device such as a Liquid Crystal Display (LCD), touch screen, and the like.

The network interface 306 enables wireless communication to an external access device or network. Any number of suitable wireless data communication protocols, techniques, or methodologies can be supported by the network interface 306, including any protocols for wireless communication. The data store 308 may be used to store data. The data store 308 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

The memory 310 may include any volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 can include one or more software programs, each of which includes an ordered listing of executable instructions for implementing logical functions. In the example of FIG. 3, the software in the memory 310 includes a suitable operating system 314 and programs 316. The operating system 314 essentially controls the execution of other computer programs and provides scheduling, input-output control, file and data management, memory management, and communication control and related services. The programs 316 may include various applications, add-ons, etc. configured to provide end-user functionality with the computing device 300. For example, example programs 316 may include, but not limited to, a web browser, social networking applications, streaming media applications, games, mapping and location applications, electronic mail applications, financial applications, and the like. The application 110 can be one of the example programs.

### § 4.0 Application for Traffic Forwarding and Monitoring

Again, the network configuration 100B includes an application 110 that is executed on the computing device 300. The application 110 can perform similar functionality as the server 200, as well as coordinated functionality with the server 200 (a combination of the network configurations 100A, 100B). Of course, various embodiments are contemplated herein, including combinations of the network configurations 100A, 100B, 100C together. For example, the application 110 can perform similar functionality as the cloud 120, as well as coordinated functionality with the cloud 120.

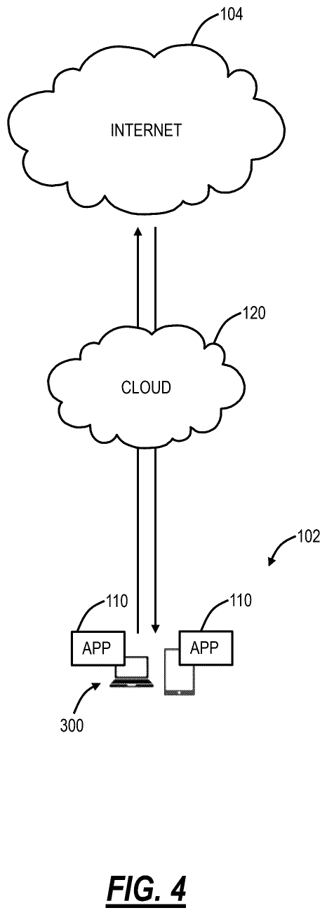

FIG. 4 is a network diagram of an exemplary network configuration illustrating an application 110 on computing devices 300 configured to operate through the cloud 120. Different types of computing devices 300 are proliferating, including Bring Your Own Device (BYOD) as well as IT-managed devices. The conventional approach for a computing device 300 to operate with the cloud 120 as well as for accessing enterprise resources includes complex policies, VPNs, poor user experience, etc. The application 110 can automatically forward user traffic with the cloud 120 as well as ensuring that security and access policies are enforced, regardless of device, location, operating system, or application. The application 110 automatically determines if a user 102 is looking to access the open Internet 104, a SaaS app, or an internal app running in public, private, or the datacenter and routes mobile traffic through the cloud 120. The application 110 can support various cloud services, including ZIA, ZPA, ZDX, etc., allowing the best in class security with zero trust access to internal applications. As described herein, the application 110 can also be referred to as a connector application.

The application 110 is configured to auto-route traffic for seamless user experience. This can be protocol as well as application-specific, and the application 110 can route traffic with a nearest or best fit node of the cloud 120. Further, the application 110 can detect trusted networks, allowed applications, etc. and support secure network access. The application 110 can also support the enrollment of the computing device 300 prior to accessing applications, the internet, or any services provided by the cloud 120. The application 110 can uniquely detect the users 102 based on fingerprinting the user device 300, using criteria like device model, platform, operating system, device posture, etc. The application 110 can support Mobile Device Management (MDM) functions, allowing IT personnel to deploy and manage the computing devices 300 seamlessly. This can also include the automatic installation of client and SSL certificates during enrollment. Finally, the application 110 provides visibility into device and app usage of the user 102 of the computing device 300.

The application 110 supports a secure, lightweight tunnel between the computing device 300 and the cloud 120. For example, the lightweight tunnel can be HTTP-based. With the application 110, there is no requirement for PAC files, an IPSec VPN, authentication cookies, or user 102 setup.

### § 5.0 Geolocation Cache Service

The present disclosure relates to systems and methods for enhancing Geolocation cache services. In general aspects, the present disclosure provides systems and methods for enhancing the accuracy of an Access Point (AP) location tracking by incorporating the egress IP address along with the Basic Service Set Identifier (BSSID) in the geolocation cache. The disclosure includes caching an AP's location based on a plurality of parameters beyond the BSSID. That is, the location of the AP is cached not solely based on its BSSID, but also by including an egress IP address. The egress IP, which can be obtained through a IP lookup service or IP address lookup tool (i.e., “whatsmyip”) or any service which can determine and optionally display a user's public-facing IP address. The IP lookup service can provide a real-time identifier of the AP's current location as it moves through different Internet Service Providers (ISPs).

When an AP moves to a different location, the egress IP can change. For example, the egress IP can change as a result of the transition between different ISPs. This change can serve as a unique key that, when combined with the BSSID, can be used to identify the AP's new location. Without the egress IP as part of the geolocation cache key, there can be a risk of returning the outdated location information. By including both the BSSID and the egress IP, the cache can be kept current and can increase the accuracy of the location data. As such, the change in the location of the AP can be detected based on monitoring its'egress IP. This can be helpful because the ISPs can differ between one or more points and can result in different egress IPs. Additionally, by utilizing other nearby access points, when available, the system and methods of the present disclosure can enhance the accuracy for fixed users as well. In some aspects, upon detecting a change in the AP location, the system can refresh the location cache by calling an external location service, which can be configured to update the geolocation information.

In typical aspects, the method generally provides an enhanced detection mechanism which can track AP movements. By tracking AP movements, the system can enhance security by detecting unusual or unexpected changes in the location and can trigger security alerts or further investigations based on the changes. Further, the method can include home agent anchoring, which can be a process of maintaining a stable home agent for mobile devices. By accurately detecting changes in the AP locations, it becomes easier to anchor mobile devices to the appropriate home agents.

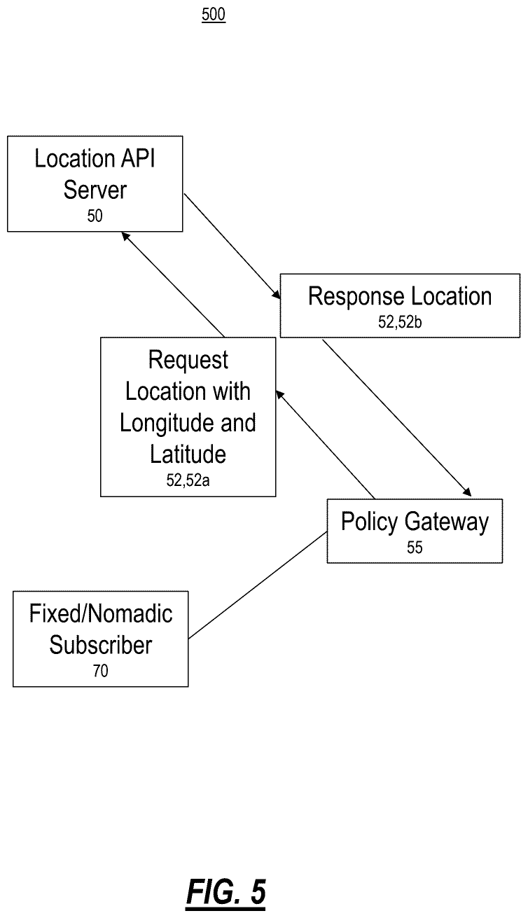

Turning now to FIG. 5, an exemplary embodiment of a geolocation structure 500. The structure 500 can include a fixed or nomadic subscriber 70. The subscriber can be a client or a user. The subscriber 70 can be a device or user that is physically located in a certain area. The area can either be fixed (i.e., a stable location) or nomadic (i.e., moving but sometimes with some predictability. In example, the subscriber 70 can be a mobile phone, a tablet, or a connected IoT device, although other user devices are contemplated. In some aspects, the subscriber 70 can send a request location 52,52a. The request location 52,52a can include a longitude and latitude of its current geolocation. The request location 52,52a can be sent to a location API server 50. The API server 50 can be configured to handle requests related to geolocation and can be operable to receive the subscriber's geolocation information (i.e., longitude and latitude.) The API server 50 can process the request and can forward the relevant data to a policy gateway 55.

In some aspects, the API server 50 can contain internal geolocation processing capabilities, for example and without limitation converting geographic coordinates into a human-readable address or region. More generally, the API server is configured to forward location data. The location data can be forwarded as a response location 52, 52b. The policy gateway 55 can be a central element responsible for enforcing specific policies and rules based on the received geolocation data. The policy gateway 55 can provide access control (i.e., deciding whether the subscriber 70 can access specific servers or content based in their location), network policies, (i.e., determining the best network paths or routing based on the geographical location), regional restrictions (i.e., implementing location-based content deliver or region-specific regulations), or similar activities. The policy gateway 55 can communicate with external systems and databases (e.g., geographic databases, policy servers, or the like) to ensure the proper rules are applied based on the location information received. The policy gateway 55 can return the response location 52,52b to the API server 50 which can include a modified or confirmed location or additional information about regional services and policies.

In example only, and without limitation, the geolocation data flow can follow steps: When the subscriber 70 sends a request to the Location API Server 50, it includes its current longitude and latitude (geolocation data). The Location API Server 50 processes the request and forwards the geolocation data to the Policy Gateway 55. The Policy Gateway 55 then applies any relevant policies based on the location, such as validating access, checking for content availability, and applying network rules. Once these policies are applied, the Policy Gateway 55 sends a response back to the Location API Server 50, which may include updated geolocation data, location-based restrictions, or additional information about the current location. The Location API Server 50 then returns the final response to the Subscriber 70, thus completing the geolocation request process.

One aspect of the present disclosure employs caching of the AP location based not only on the BSSID but also on the egress IP address of the AP at a given time. The egress IP, whether IPv4 or IPv6, can be obtained using tools such as “whatismyip” or similar services, which provide the current location of the AP. As the AP moves across different ISPs, the egress IP changes, serving as a unique key for identifying the AP's location along with its associated latitude and longitude. This method helps avoid the issue of returning outdated geolocation data, which can occur when relying solely on the BSSID. By combining the BSSID and egress IP in the cache key, the system ensures that geolocation data remains accurate, even as the AP traverses multiple network providers. Furthermore, the system detects AP movement by monitoring changes in the egress IP, as the ISP often changes when the AP moves from one location to another. This solution also incorporates nearby access points, where available, to further refine location data. In cases where the AP location is detected to have changed, the system refreshes the location cache by making a call to an external location service. Additionally, this approach has potential applications beyond geolocation, such as enhancing security monitoring or supporting home agent anchoring in network management.

### § 5.1 Process

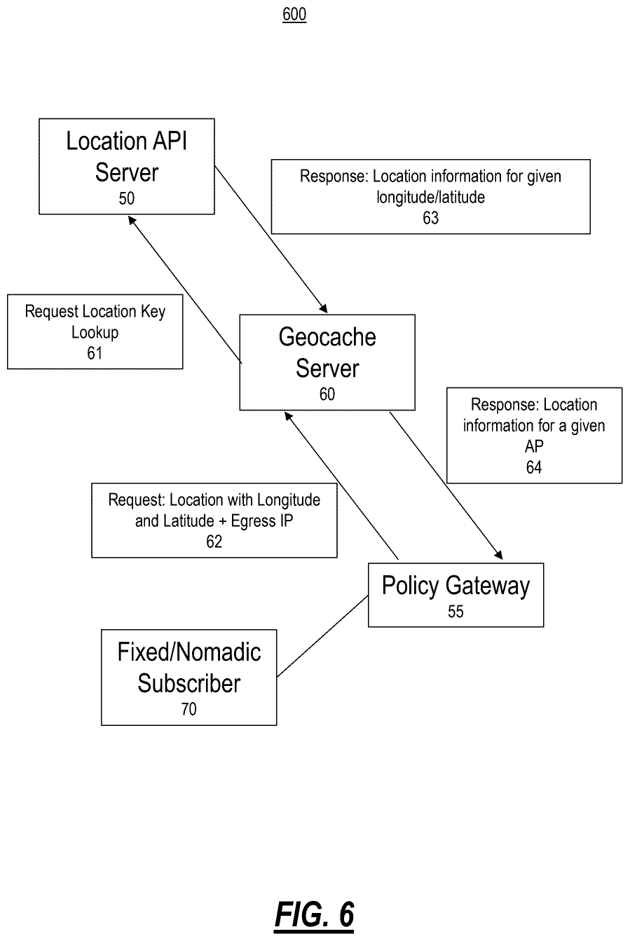

Turning now to FIG. 6, an advanced geolocation architecture 600 is shown and described. The advanced geolocation architecture 600 can include the subscriber 70. The subscriber 70 can be either a device or user which can request location-based services. The subscriber 70 can be either a fixed entity (e.g., a home router) or a nomadic entity (e.g., a mobile hotspot moving between a first location and a second location). The subscriber 70 can be operable to send a request containing geographical information, such as longitude, latitude, and egress IP. Notably, the subscriber 70 can send an egress IP or any other IP address. The architecture 600 can include the API server 50. The API server 50 can be structured to handle geolocation queries from the subscriber 70. In example, the API server 50 can retrieve location data either from a geocache server 60 or an external database. From there, the API server 50 can respond with geolocation information.

The geocache server 60 can be a caching system which can store location information based on parameters, such as on the BSSID or egress IP. In some aspects, the geocache server 60 can prevent outdated location results by keeping updated entries, for example on a list. As such, the geocache server 60 can reduce latency and external API calls by serving cached location data. The architecture 600 can include the policy gateway 55. The policy gateway 55 is configured to enforce rules and can access control based geolocation data. In example, the policy gateway 55 can use geolocation data for security, network policies, regional restrictions or service access control. The policy gateway 55 can be configured to query the geocache server 60 when needed. Again, an important aspect of the architecture is that the AP location is based on the BSSID and the egress IP of the AP at a given instant.

The following is an illustrative example of a process according to the present disclosure and is intended to be understood without limitation: The process begins with the subscriber 70 initiating a location request 62, which includes its current physical coordinates (longitude and latitude) and its egress IP, the external/public IP assigned by the ISP that helps detect movement. This request is then sent to the Geocache Server 60 to ensure processing of location data without solely relying on external databases. The Location API Server 50 subsequently requests location information from the Geocache Server, based on the provided longitude and latitude, or the egress IP and BSSID if cached data is needed. The Geocache Server 60 processes the request and returns location data to the Location API Server 50 if a cache entry exists for the BSSID +Egress IP. If the data is missing or outdated, it queries an external geolocation database and updates the cache. The Policy Gateway 55 may also request location information for a given AP to apply location-based policies, such as access control, network routing, and security monitoring. Finally, once the location information is retrieved and policies are applied, a final response 64 is sent back to the Location API Server 50, which then delivers the location result to the subscriber 70.

When the subscriber 70 initiates the location request 62, it includes its current physical coordinates (longitude and latitude) and the egress IP assigned by the ISP. This request is sent to the Geocache Server 60 to process the location data without solely relying on external databases. The API server 50 then requests location information from the Geocache Server 60 based on the provided coordinates or cached egress IP and BSSID data. The Geocache Server 60 processes the request and either returns the cached location data or queries an external geolocation database if the data is outdated. The response includes the exact geographical coordinates, country, city, region data, ISP details, and the accuracy level. The Policy Gateway 55 may also request this location data to apply policies such as access control, network routing, and security monitoring. Finally, the Location API Server 50 delivers the updated location information to the subscriber 70, ensuring accurate and real-time geolocation tracking.

The Geocache server 60 can send a Location Key Lookup request 61 to the API Server 50 to fetch the latest location information for the provided coordinates, which can provide tracking of mobile subscribers. The API server 50 then processes the request, querying its databases to retrieve precise geolocation details 63, which can include country, city, region, latitude, longitude, timestamp of the last verification, and possibly additional ISP/network metadata. This information is then sent back to the Geocache Server 60, which updates its cache with the new data. By doing so, future requests for the same AP location can be resolved quickly without querying the API server 50 again.

In some aspects, the disclosure provides a method for accurately determining and caching the location of the AP by leveraging network identifiers and the AP's egress IP address. The method involves storing the AP's geolocation information in a cache based on network identifiers like BSSID (MAC address) and other relevant data, which prevents repeated queries to external location services. The egress IP, obtained through external tools like “WhatIsMyIP,” serves as a unique identifier since it changes when the AP moves between different ISPs or locations. By combining the egress IP with other identifiers to create a unique cache key, the system avoids returning outdated location data. When the unique key is generated, it fetches the corresponding geolocation data, where accurate location data is retrieved based on the key. If the AP has moved, the system refreshes the cache by calling an external geolocation service. The Geocache Server implements this caching method, ensuring the AP location data remains up to date. The method can include retrieving fresh location data when needed, and can ensure the inclusion of egress IP in the location request for improved accuracy. The Policy Gateway can enforce rules based on this geolocation, applying security policies when an AP moves. This method can decrease the prevalence of incorrect geolocation when an AP moves across different ISPs, ensuring accurate location tracking and enhancing security, location-based policies, and network efficiency.

The BSSID is the unique MAC address of the AP, helping identify a specific AP within a network. However, it alone is insufficient for accurate geolocation if the AP moves to a different ISP, which is why the request includes the egress IP to ensure the location remains correct. The egress IP address, assigned by the ISP and changing when the AP moves, updates as the AP connects to a new network or ISP. By using both BSSID and egress IP, the system can detect when an AP has changed locations and avoid returning outdated geolocation data. The Geocache Server relies on both BSSID and egress IP to create a unique cache key for accurate location tracking. The request ensures that when a location request is made, the system checks both the BSSID and the latest egress IP before returning cached results. The response fetches fresh geolocation data if needed, ensuring that the egress IP is accounted for in identifying the correct AP location. Using only the BSSID could lead to stale or incorrect location data if the AP moves but keeps the same MAC address, while using only the egress IP might not work if multiple APs share the same public IP behind a NAT. Combining both BSSID and egress IP ensures accurate geolocation tracking, prevents security loopholes, and allows for better policy enforcement in systems like the Policy Gateway (55).

The egress IP plays a role in detecting AP movement, as the ISP assigns a new IP when the AP moves between networks. The system derives this egress IP using external tools like “whatismyip,” which provides the AP's public-facing IP, applicable to both IPv4 and IPv6 addresses. The method can include support for both IPv4 and IPv6 networks, as IPv4 remains the dominant internet protocol with limited addresses, while IPv6 offers a larger address space and is increasingly adopted by ISPs. This provision allows the system to track AP locations regardless of the IP protocol used, preventing failures in detecting movements when networks primarily operate on IPv6. By caching both IPv4 and IPv6 egress addresses, the system maintains accurate tracking even when the AP switches to different ISPs or network environments, avoiding outdated location data. The request can include either IPv4 or IPv6, or any other parameter which can provide location tracking across various network infrastructures. Further, the request can check for both IP types in the cache before external queries. The response can return geolocation data for either IP type. This compatibility with both IPv4 and IPv6 encourages the system's flexibility and scalability, preventing geolocation errors when APs move between networks using different IP protocols and strengthening the caching mechanism to avoid outdated or incorrect location data.

In typical aspects, the present disclosure can present geographical information in some coordinates. Longitude and latitude, globally recognized as precise geographic coordinates, can be used and are configured to such that the AP's location is stored and retrieved accurately in a standardized format. These coordinates are preferred over street addresses, which can be ambiguous, ISP-based geolocation, which may only provide a general area, and network-based locations like cell tower triangulation, which can be less precise. By using longitude and latitude, the system benefits from GPS-level accuracy when available. In the context of AP geolocation, when an AP's egress IP is derived, its location is identified based on these precise coordinates. The Geocache Server then stores this data using longitude/latitude values instead of other location representations. If the AP moves, the system can refresh the geolocation by requesting new longitude/latitude coordinates. However, other measurements are envisioned for transmitting geographical information.

The egress IP address, which can be assigned by the ISP when an AP connects to the internet, acts as a key indicator for AP relocation. When the AP moves to a different network or geographical location, the egress IP changes, signaling the movement. Traditional methods like GPS may not always be available for APs, especially indoors, but egress IP tracking allows for movement detection without relying on GPS, making it useful for Wi-Fi-based devices. Different ISPs serve various regions, so a change in egress IP usually correlates with a change in physical location. When an egress IP change is detected, the system requests updated geolocation data from an external service, such as a location API like “whatismyip.” The Geocache Server (60) updates its cached location entry to reflect the new longitude and latitude, ensuring location-based services always have the most current AP geolocation information.

The egress IP address, the external IP address assigned to the AP by its Internet ISP for outgoing traffic, is used as a secondary key in the cache alongside the BSSID, which uniquely identifies the AP itself. The BSSID, typically a MAC address, is a unique identifier commonly used to identify the AP. However, as the AP moves through different ISPs or networks, its egress IP address may change, affecting the associated geolocation. The cache key, a unique identifier used to store and retrieve geolocation data, combines the BSSID and the egress IP to ensure the AP's location in the cache reflects its current location. By including the egress IP in the cache key, the system avoids outdated geolocation data that could be returned if only the BSSID was used. For example, if AP1 has a BSSID of 00:11:22:33:44:55 and is connected through ISP1 with egress IP 1.2.3.4, the cache key would be 00:11:22:33:44:55+1.2.3.4. If the AP moves to a different location and the ISP changes, the egress IP might change to 5.6.7.8, updating the cache key to 00:11:22:33:44:55+5.6.7.8. This method ensures accurate tracking and caching of the AP's current location based on both its BSSID and egress IP, improving the accuracy of geolocation services.

The method can include a proximal AP. The proximal AP refers to an AP that is geographically close to the original AP whose location is being determined. A second proximal AP is another nearby AP, distinct from the primary one being tracked, used to help verify or estimate the location of the first AP. Referencing the location involves using the location information of the second AP to cross-check or derive the primary AP's location. This method is particularly useful when the primary AP's location is hard to determine directly, such as when its egress IP address is unreliable, or the AP has moved. By looking at the location of a nearby second AP, the system can infer the location of the primary AP, especially if both are within the same area or network. For example, if AP1 is located in a building and AP2 is in the same building or nearby, the system can use the known location of AP2 to infer that AP1 is in the same area. This referencing method ensures accuracy, with the location of AP1 being cross-checked against the known location of AP2.

In typical aspects, the AP can be a fixed user Ap or a mobile AP. A Fixed User AP refers to an AP that is stationary and located in a fixed, predefined location, such as a wireless router in a home, office, or data center. These APs do not move, and their location is predictable, allowing their geolocation to be determined and cached reliably based on their static position. In contrast, a Mobile AP refers to an AP that is mobile or capable of changing locations, such as a mobile hotspot, a vehicle equipped with Wi-Fi, or an AP deployed on a moving device like a bus, train, or drone. The location of a mobile AP changes as it moves, requiring dynamic tracking of its geolocation. The distinction between these two types of APs is important because it affects how the system handles their geolocation. For a fixed user AP, the location remains stable over time, so the system can cache the geolocation once and use it as a reference. Conversely, for a mobile AP, the location can change frequently, necessitating active tracking and updating of its location using the egress IP or other means like the proximity of other APs. This distinction ensures that the geolocation cache remains accurate and up to date, reflecting the current location of the AP, whether it is fixed or mobile.

The method can incorporate triangulation to determine a geolocation. Triangulation is a method of location determination that involves measuring the distances or angles from at least three known reference points to calculate the position of an object, such as the AP. There are two main types of triangulation: angle-based triangulation, which measures the angles between the object and at least two known reference points, and distance-based triangulation (trilateration), which measures the distances from the object to several fixed points. In the context of geolocation, the system uses multiple known APs or other fixed devices with predetermined coordinates as reference points. The system calculates either the angles or distances between the AP being located and the reference points using signal strength (RSSI), direction of the signal, or time-based methods (like time-of-flight). Triangulation formulas are then applied to calculate the exact position of the AP based on the intersection of the calculated ranges from multiple reference points. Triangulation is effective for geolocation because it provides precise location data if reference points are accurately placed, works in both 2D and 3D space, and improves accuracy with more reference points. For example, to determine the geolocation of a mobile AP, the system measures the signal strength or time-of-flight from three fixed APs in known locations to the mobile AP and calculates its location based on where these measurements intersect. In summary, triangulation allows the system to calculate an AP's position by measuring its relative position to multiple known reference points and applying triangulation techniques for accurate location determination.

In typical aspects, the method can include performing a triangulation based on the egress IP. In example only, to perform triangulation based on the egress IP, the system first determines the geographic location of the egress IP using IP geolocation databases or services, which map IP addresses to approximate physical locations. When an AP moves and switches between different ISPs or networks, its egress IP address changes, providing clues about the AP's location, as different ISPs assign IP address ranges based on geography. The system can use multiple egress IP addresses from different ISPs or networks to triangulate the AP's location. By analyzing the geolocation of these egress IPs, the system can roughly deduce the AP's location. For example, if the AP connects through egress IP A (geolocated to Location 1) and later connects through egress IP B (geolocated to Location 2), the system can infer that the AP is somewhere between these locations. With additional egress IPs, the system can further refine the location, creating a “triangle” of possible locations. Unlike traditional triangulation, which uses physical reference points, triangulation based on egress IP relies on geolocating the IP addresses to estimate the AP's position. The accuracy of this method depends on the precision of the IP geolocation data, which is typically approximate. As the egress IP changes with the AP's movement, this triangulation method helps track the mobile AP's movement when GPS or physical reference data is unavailable. For instance, if an AP moves from one city to another and gets new egress IPs from different ISPs, the system can estimate the AP's movement and approximate location. Similarly, if the AP moves within a region and its egress IP addresses change due to switching networks, triangulation can determine its approximate position. In summary, triangulation based on egress IP uses the geolocation data of multiple egress IP addresses to estimate the AP's position. As the AP changes its egress IP, the system refines the AP's location, making this method useful for mobile APs or situations where traditional triangulation is not feasible.

### § 5.2 Example Use Cases

Again, in an embodiment, disclosed is a method configured to determine the location of an AP, particularly when dealing with nomadic subscribers who may move the AP to different locations. The process includes caching the AP's location based on its network identifiers, such as its MAC address (BSSID) or an IP address associated with the AP. This allows for a lookup without needing to repeatedly query an external service, improving efficiency. The egress IP address, which is the public-facing IP address of the AP when it connects to the internet, can be obtained via external services like “whatismyip.” The egress IP provides a more accurate indicator of the AP's current location since it reflects the location of the ISP or network gateway the AP is connected to.

By using the egress IP address, the system generates a unique cache key. Associating the AP's geolocation with this egress IP helps avoid outdated location data caused by the movement of the AP, making the IP address a reliable, location-specific identifier. The system can now accurately determine the geolocation of the AP using the unique key (BSSID+egress IP), typically represented in longitude and latitude coordinates. The method also includes monitoring AP movement by detecting changes in its egress IP address. As the AP moves and connects through different ISPs, its egress IP changes, and the system updates the geolocation cache accordingly to ensure the location data stays current.

Additionally, the egress IP can serve as a secondary cache key, allowing the system to reference different geolocations associated with the same BSSID at different times or locations. If another nearby AP has a known location, it can be used as a reference point to improve the accuracy of the cached geolocation data, especially if the primary AP's location is uncertain. This method works for both stationary (fixed) and mobile APs, with the egress IP helping detect location changes and update the geolocation cache accordingly.

Triangulation is a technique used to determine the geolocation of the AP by measuring the distance from multiple reference points, typically using the known locations of other APs. The egress IP can assist in triangulating the AP's position by leveraging data from multiple ISPs or access points, improving the accuracy of location determination. This approach addresses several problems, particularly with nomadic subscribers whose APs may move to different locations. Using the BSSID alone often leads to outdated or incorrect location data, as the system assumes the AP remains in a fixed position. By including the egress IP in the location determination process, the system can more accurately track the AP's movement.

However, simply including latitude and longitude as part of the cache key could create inefficiency and data overload, as every minor change in location would create a new cache entry. Additionally, avoiding caching entirely and relying on external services would lead to increased latency, higher costs, and vulnerability to network failures. This method balances between efficient caching and accurate location tracking, particularly for mobile APs. In summary, the system uses a combination of the AP's BSSID, egress IP, and geolocation data to efficiently track and cache the location of the AP, while mitigating the challenges posed by nomadic or mobile users.

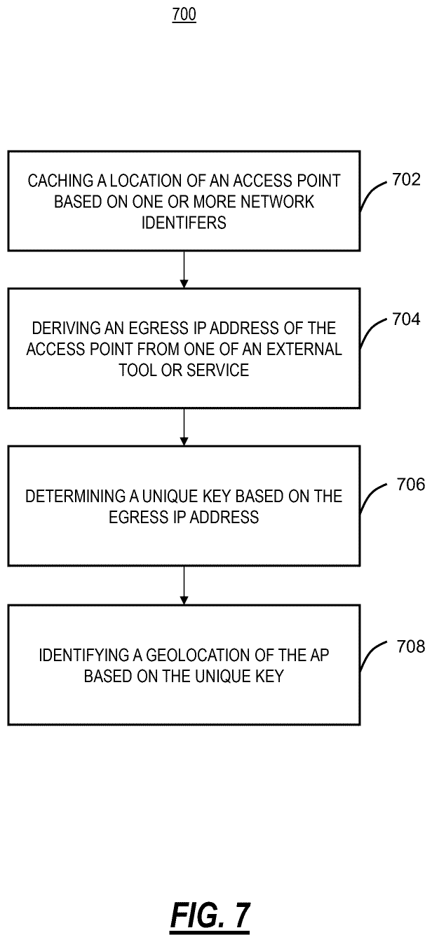

Turning now to FIG. 7, diagram depicting an exemplary aspect 700 of a geolocation architecture 600 is shown and described. The method can include caching 702 a location of an Access Point (AP) based on one or more network identifiers of the AP. The method can include deriving 704 an egress IP address of the AP from one of an external tool or service. The method can include determining 706 a unique key based on the egress IP address. The method can include identifying 708 a geolocation of the AP based on the unique key.

In typical aspects, the method can include wherein the one or more network identifiers are any of a Basic Service Set Identifier (BSSID) and an egress IP address. The method can include wherein the egress IP address is one of IPv4 and IPv6. The method can include wherein the geolocation is defined in longitude and latitude. The method can include further comprising: monitoring an AP movement by detecting a change in the egress IP address; and updating the geolocation based on the movement of the egress IP address of the AP.

In typical aspects, the method can include wherein the egress IP address defines a second cache key. The method can include further comprising referencing the location based on a second proximal AP. The method can include wherein the AP is one of a fixed user AP or a mobile AP. The method can include wherein the geolocation is determined via a triangulation. The method can include wherein the triangulation is based on the egress IP.

### § 6.0 Conclusion

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each potentially equipped with one or more processors. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

While the present disclosure has been detailed and depicted through specific embodiments and examples, it is to be understood by those skilled in the art that numerous variations and modifications can perform equivalent functions or yield comparable results. Such alternative embodiments and variations, which may not be explicitly mentioned but achieve the objectives and adhere to the principles disclosed herein, fall within its spirit and scope. Accordingly, they are envisioned and encompassed by this disclosure, warranting protection under the claims associated herewith. Additionally, the present disclosure anticipates combinations and permutations of the described elements, operations, steps, methods, processes, algorithms, functions, techniques, modules, circuits, etc., in any manner conceivable, whether collectively, in subsets, or individually, further broadening the ambit of potential embodiments.

What is claimed is:

1. A method comprising steps of:
caching a location of an Access Point (AP) based on one or more network identifiers of the AP;
deriving an egress Internet Protocol (IP) address of the AP from one of an external tool or service;
determining a unique key based on the egress IP address; and
identifying a geolocation of the AP based on the unique key.

2. The method of claim 1, wherein the one or more network identifiers are any of a Basic Service Set Identifier (BSSID) and an egress IP address.

3. The method of claim 2, wherein the egress IP address is one of IPv4 and IPv6.

4. The method of claim 1, wherein the geolocation is defined in longitude and latitude.

5. The method of claim 1, further comprising:
monitoring an AP movement by detecting a change in the egress IP address; and
updating the geolocation based on the movement of the egress IP address of the AP.

6. The method of claim 1, wherein the egress IP address defines a second cache key.

7. The method of claim 1, further comprising:
referencing the location based on a second proximal AP.

8. The method of claim 1, wherein the AP is one of a fixed user AP or a mobile AP.

9. The method of claim 1, wherein the geolocation is determined via a triangulation.

10. The method of claim 9, wherein the triangulation is based on the egress IP.

11. A non-transitory computer-readable medium comprising instructions that, when executed, cause one or more processors to perform steps of:
caching a location of an Access Point (AP) based on one or more network identifiers of the AP;
deriving, at an instant, an egress Internet Protocol (IP)address of the AP from one of an external tool or service;
determining a unique key based on the egress IP address; and
identifying a geolocation of the AP based on the unique key.

12. The non-transitory computer-readable medium of claim 11, wherein the one or more network identifiers are any of a Basic Service Set Identifier (BSSID) and an egress IP address.

13. The non-transitory computer-readable medium of claim 12, wherein the egress IP address is one or both of IPv4 and IPv6.

14. The non-transitory computer-readable medium of claim 11, wherein the geolocation is defined in longitude and latitude.

15. The non-transitory computer-readable medium of claim 11, further comprising:
monitoring an AP movement by detecting a change in the egress IP address; and
updating the location based on the movement of the egress IP address of the AP.

16. The non-transitory computer-readable medium of claim 11, wherein the egress IP address defines a second cache key.

17. The non-transitory computer-readable medium of claim 11, further comprising referencing the location based on a second proximal AP.

18. The non-transitory computer-readable medium of claim 11, wherein the AP is one of a fixed user AP or a mobile AP.

19. The non-transitory computer-readable medium of claim 11, wherein the geolocation is determined via a triangulation algorithm.

20. The non-transitory computer-readable medium of claim 19, wherein the triangulation is based on the egress IP.
